(19) United States
(12) Patent Application Publication
(10) Pub. No.: US 2026/0063768 A1
(43) Pub. Date: Mar. 5, 2026

(54) Lidar Sensor with Ultra Wide Field of View Using Two Vertically Oriented Lenses

(71) Applicant: Microvision, Inc., Redmond, WA (US)

(72) Inventors: Kilian Stumpf, Egestorf (DE); Till Steinbach, Hamburg (DE)

(73) Assignee: Microvision, Inc., Redmond, WA (US)

(21) Appl. No.: 18/825,117

(22) Filed: Sep. 5, 2024

(51) Int. Cl. G01S 7/481; G01S 17/931

(52) U.S. Cl. CPC G01S 7/4813; G01S 17/931

(57) ABSTRACT

Aspects of the subject disclosure may include, for example, a LIDAR measurement system that includes a transmitter module, a transmitter lens system, a receiver module, and a receiver lens system. The transmitter module and receiver module are positioned within a housing, and the transmitter lens system and receiver lens system protrude through a bezel outside the housing. Other embodiments are disclosed.

### FIELD OF THE DISCLOSURE

The subject disclosure relates to Light Detection And Ranging (LIDAR) measurement systems.

### BACKGROUND

LIDAR measurement systems are commonly used in automotive applications to measure distances between a vehicle and objects around the vehicle. LIDAR measurement systems are typically recessed in a vehicle body panel (e.g., front bumper cover) for aesthetic reasons.

### BRIEF DESCRIPTION OF THE DRAWINGS

Reference will now be made to the accompanying drawings, which are not necessarily drawn to scale, and wherein:

FIG. 1 shows a LIDAR measurement system in accordance with various aspects described herein;

FIG. 2 shows a transmitter module and a receiver module schematically in a front view in accordance with various aspects described herein;

FIGS. 3 and 4 show automotive applications of LIDAR measurement systems in accordance with various aspects described herein;

FIG. 5 shows a perspective view of a LIDAR measurement system in accordance with various aspects described herein;

FIG. 6 shows a cross section view of a LIDAR measurement system in accordance with various aspects described herein;

FIG. 7 shows a cross section view of a transmitter module and lens system in accordance with various aspects described herein;

FIG. 8 shows transmitter and receiver modules centered on lens systems in accordance with various aspects described herein;

FIG. 9 shows transmitter and receiver modules offset on lens systems in accordance with various aspects described herein;

FIG. 10 depicts an illustrative embodiment of a method in accordance with various aspects described herein.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. Like numerals in the drawings refer to the same or similar functionality throughout the several views.

One or more aspects of the subject disclosure include a system, comprising a housing; a transmitter module positioned within the housing, the transmitter module including a plurality of emitter elements to emit laser light pulses into a field of view; a transmitter lens system optically coupled to the transmitter module, the transmitter lens system positioned at least partly outside the housing to provide a wide transmitter horizontal field of view; a receiver module positioned within the housing, the receiver module including a plurality of sensor elements to detect reflected laser light pulses from the field of view; and a receiver lens system optically coupled to the receiver module, the receiver lens system positioned at least partly outside the housing to provide a wide receiver horizontal field of view.

Additional aspects of the subject disclosure include the transmitter module being positioned relative to the transmitter lens system to provide a symmetric vertical field of view, and the transmitter module being positioned relative to the transmitter lens system to provide an asymmetric vertical field of view. Further aspects include time-of-flight measurement circuitry coupled to the receiver module to measure times-of-flight of the reflected laser light pulses, the transmitter module and the transmitter lens system being positioned vertically above the receiver module and the receiver lens system, the receiver module and the receiver lens system being positioned vertically above the transmitter module and the transmitter lens system, and the housing comprising a bezel, and wherein the transmitting lens system and receiving lens system protrude through holes in the bezel. Further aspects include the transmitting lens system and the receiving lens system being oriented vertically, and wherein one of the transmitting lens system and the receiving lens system protrudes further outside the housing than an other of the transmitting lens system and the receiving lens system; and wherein the one of the transmitting lens system and the receiving lens system that protrudes further outside the housing is positioned vertically above the other of the transmitting lens system and the receiving lens system. Further aspects include the transmitter horizontal field of view being at least 180 degrees and the receiver horizontal field of view being at least 180 degrees. Further aspects include the housing being positioned adjacent to an inside surface of a vehicle body panel, and wherein the transmitting lens system and the receiving lens system protrude through the vehicle body panel.

One or more aspects of the subject disclosure include a light detection and ranging (LIDAR) measurement system, comprising a transmitter module and transmitter lens system oriented on a vertical axis of the LIDAR measurement system; and a receiver module and receiver lens system oriented on the vertical axis of the LIDAR measurement system, wherein one of the transmitter lens system and the receiver lens system is a top lens system, and an other of the transmitter lens system and the receiver lens system is a bottom lens system; wherein the top lens system and bottom lens system are positioned to protrude through a bezel, and wherein the top lens system is positioned to protrude further through the bezel than the bottom lens system to provide an increased lower vertical field of view.

Additional aspects of the subject disclosure include the top lens system comprising the transmitter lens system and the bottom lens system comprising the receiver lens system, and the top lens system comprising the receiver lens system and the bottom lens system comprising the transmitter lens system. Further aspects include the transmitter module including an array of emitter elements capable of emitting laser light pulses, and the transmitter module being positioned off center with respect to a first principal axis of the transmitter lens system; and the receiver module including an array of sensor elements capable of detecting reflections of the laser light pulses, and the receiver module being positioned off center with respect to a second principal axis of the receiver lens system. Further aspects include the transmitter lens system comprising a first fisheye lens that provides a first horizontal field of view at least 180 degrees, and the receiver lens system comprising a second fisheye lens that provides a second horizontal field of view at least 180 degrees.

One or more aspects of the subject disclosure include a method, comprising producing a laser light pulse at an emitter positioned within a housing; propagating the laser light pulse through a first lens system positioned to protrude outside the housing, the first lens system providing a first horizontal field of view of at least 180 degrees; receiving a reflection of the laser light pulse at a second lens system positioned to protrude outside the housing, the second lens system providing a second horizontal field of view of at least 180 degrees; detecting the reflection of the laser light pulse at a sensor element optically coupled to the second lens system, wherein the sensor element is positioned within the housing; and measuring the time-of-flight of the laser light pulse.

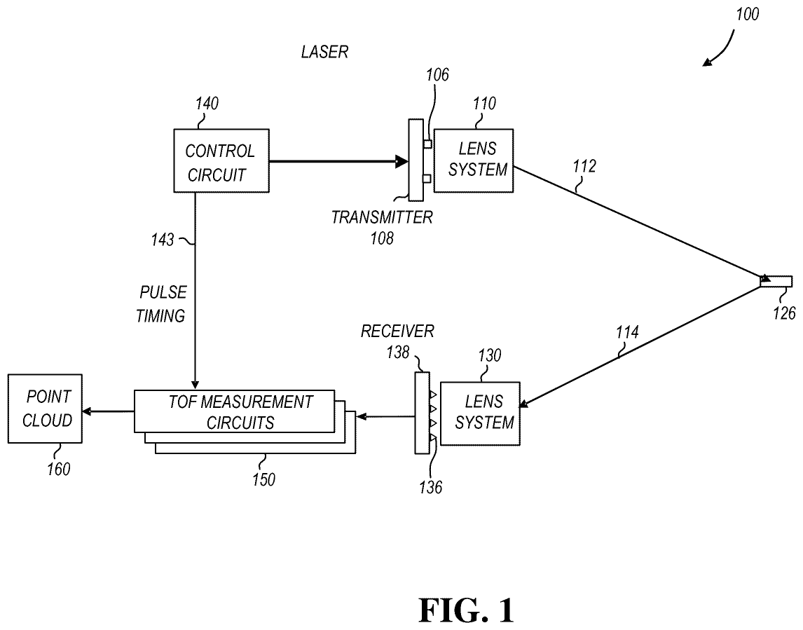

FIG. 1 shows the structure of a LIDAR measuring system 100 in schematic form. Measuring system 100 may be used in any LIDAR application. For example, in some embodiments, measuring system 100 is intended for use on a motor vehicle. As further described below, measuring system 100 may be arranged statically on a motor vehicle and, in addition, is conveniently designed statically itself. This means that the measuring system 100, as well as its components and modules, do not perform any relative movement with respect to each other.

System 100 includes control circuit 140, transmitter module 108, transmitter lens system 110, receiver module 138, receiver lens system 130, time-of-flight (TOF) measurement circuits 150, and point cloud storage device 160.

The transmitter module 108 includes a multiplicity of emitter elements 106, which for clarity of presentation are shown schematically as squares. The receiver module 138 includes a multiplicity of sensor elements 136. The sensor elements 136 are shown schematically by triangles. Although the emitter elements 106 and sensor elements 136 are shown as squares and triangles, the actual shape of emitter elements 106 and sensor elements 136 can differ from the schematic representation. For example, the emitter elements 106 may be formed by vertical cavity surface-emitting lasers (VCSELs). Also for example, the sensor elements 136 may be formed by single photon avalanche diodes (SPADs). VCSELs and SPADs are provided as examples. Any suitable laser light pulse emitters and sensors may be utilized.

In some embodiments, the transmitter module 108 and the receiver module 138 are designed in a focal plane array (FPA) configuration, where the module and its associated elements are arranged on a particular flat plane. In some embodiments, the respective plane may be arranged at the focal point or in the focal plane of an optical element, such as transmitting lens system 110 and receiving lens system 130. For example, the emitter elements 106 may be arranged on a plane of the transmitter module 108 that is located within the measuring system 100 at the focal plane of the transmitting lens system 110. Similarly, the sensor elements 136 may be arranged on a plane of the receiver module 138 that is located within the measuring system 100 at the focal plane of the receiving lens system 130.

A laser light pulse emitted by an emitter element 106 or a laser light pulse incident on a sensor element 136 passes through the respective lens system 110, 130. The transmitting lens system 110 assigns a specific solid angle to each emitter element 106. Likewise, the receiving lens system 130 assigns a specific solid angle to each sensor element 136. As FIG. 1 shows a schematic representation, the solid angle in FIG. 1 is not shown correctly. In particular, the distance from the measuring system to the object is many times greater than the dimensions of the measuring system itself.

Transmitter module 108 is oriented relative to transmitter lens system 110 such that a laser light pulse emitted by a particular emitter element 24 is always radiated by the transmitting lens system 110 into the same solid angle. Due to the orientation of the receiver module 138 relative to the receiving lens system 130, the sensor elements 136 also always observe the same solid angle. Accordingly, a sensor element 136 is always assigned to the same emitter element 106. In particular, a sensor element 136 and an emitter element 106 observe the same solid angle. In some embodiments, there is a one-to-one correspondence between emitter elements and sensor elements. Also in some embodiments, there is a one-to-many correspondence between emitter elements and sensor elements. For example, as shown in FIG. 1, a multiplicity of sensor elements 136 may be assigned to a single emitter element 106. The sensor elements 136 which are assigned to a common emitter element 106 are referred to as being part of a macro cell, where the macro cell is assigned to the common emitter element.

An emitter element 106 emits laser light in the form of a laser light pulse at 112 at the beginning of a measurement cycle. This laser light pulse propagates through the transmitting lens system 110 and is emitted into the solid angle assigned to the emitter element 106. If an object 126 is located within this solid angle, at least part of the laser light pulse is reflected from it. The reflected laser light pulse coming from the corresponding solid angle is propagated through the receiving lens system 110 onto the associated sensor element 136 or the sensor elements 136 belonging to a macro cell. The sensor element(s) 136 detect the incident laser light pulse, wherein an indication of the triggering of the sensor elements 136 is provided to one or more of time-of-flight (TOF) measurement circuits 150, and a corresponding distance measurement is written into the point cloud storage device 160. Using the time-of-flight method, the distance from the object 126 to the measuring system 100 can be determined from the round trip transit time of the laser light pulse.

The sequence of such a measurement cycle is controlled by the control circuit 140. In some embodiments, the control circuit 140 is connected or can be connected to other electronic components of a motor vehicle. For example, control circuit 140 may exchange data over a CAN bus within a motor vehicle. The control circuit 140 is shown in FIG. 1 as a single schematic building block. In some embodiments, control circuit 140 may be distributed over a multiplicity of components or assemblies of the measuring system 100. For example, in some embodiments, all or part of the control circuit 140 may be implemented on the receiver module 138.

Control circuit 140 determines laser drive properties and drives transmitter module 108 with signal(s) that cause the emitter element(s) 106 to emit laser light pulses having the specified properties. For example, control circuit 140 may determine values for laser drive power, pulse rate, pulse width, and number of multishot pulses.

Control circuit 140 is implemented using functional circuits such as phase lock loops (PLLs), filters, adders, multipliers, registers, processors, memory, and the like. Accordingly, control circuit 140 may be implemented in hardware, software, or in any combination. For example, in some embodiments, control circuit 140 is implemented in an application specific integrated circuit (ASIC). Further, in some embodiments, some of the faster data path control is performed in an ASIC and overall control is software programmable.

Time-of-flight (TOF) measurement circuits 150 are each coupled to one or more of the sensor elements 136 or one or more of the macro cells to which the sensor elements 136 may be assigned. TOF measurement circuits 150 receive laser light pulse timing information 143 from control circuit 140 and compare it to the timing of received laser light pulses to measure round trip times-of-flight of light pulses, thereby measuring the distance (Z) to the point in the field of view from which the laser light pulse was reflected. Accordingly, TOF measurement circuits 150 measure the distance between LIDAR measurement system 100 and measurement points in the field of view at which laser light pulses are reflected.

TOF measurement circuits 150 may be implemented with any suitable circuit elements. For example, in some embodiments, TOF measurement circuits 150 include digital and/or analog timers, integrators, correlators, comparators, registers, adders, or the like to compare the timing of the reflected laser light pulses with the pulse timing information received from control circuit 140.

Point cloud storage 160 receives TOF information corresponding to distance (Z) information from TOF measurement circuits 150. In some embodiments, the TOF measurements are held in point cloud storage 160 in an array format such that the location within point cloud storage 160 indicates the location within the field of view from which the measurement was taken. In other embodiments, the TOF measurements held in point cloud storage 160 include (X, Y) position information as well as TOF measurement information to yield (X, Y, Z) as a three-dimensional (3D) data set that represents a depth map of the measured portion of the field of view 128. The point cloud data may then be used for any suitable purpose. Examples include 3D imaging, velocity field estimation, object recognition, and the like.

Point cloud storage 160 may be implemented using any suitable circuit structure. For example, in some embodiments, point cloud storage 160 is implemented in a dual port memory device that can be written on one port and read on a second port. In other embodiments, point cloud storage 160 is implemented as data structures in a general purpose memory device. In still further embodiments, point cloud storage 160 is implemented in an application specific integrated circuit (ASIC).

In some embodiments, transmitting lens system 110 and receiving lens system 130 are designed to provide a wide field of view in at least one dimension. For example, in some embodiments, LIDAR measurement system 100 has a horizontal field of view (HFOV) of at least 120 degrees, at least 160 degrees, or at least 180 degrees. Various embodiments maintain spatial relationships between the lens systems and a housing (not shown in FIG. 1) that provide the ability for a wide HFOV (e.g., equal to or greater than 180 degrees).

In some embodiments, transmitter module 108 is oriented relative to transmitting lens system 110 provide a symmetric vertical field of view, and in other embodiments, transmitter module 108 is oriented relative to transmitting lens system 110 to provide an asymmetric vertical field of view. Similarly, in some embodiments, receiver module 138 is oriented relative to receiver lens system 130 provide a symmetric vertical field of view, and in other embodiments, receiver module 138 is oriented relative to receiver lens system 130 to provide an asymmetric vertical field of view. These and other embodiments are further described below.

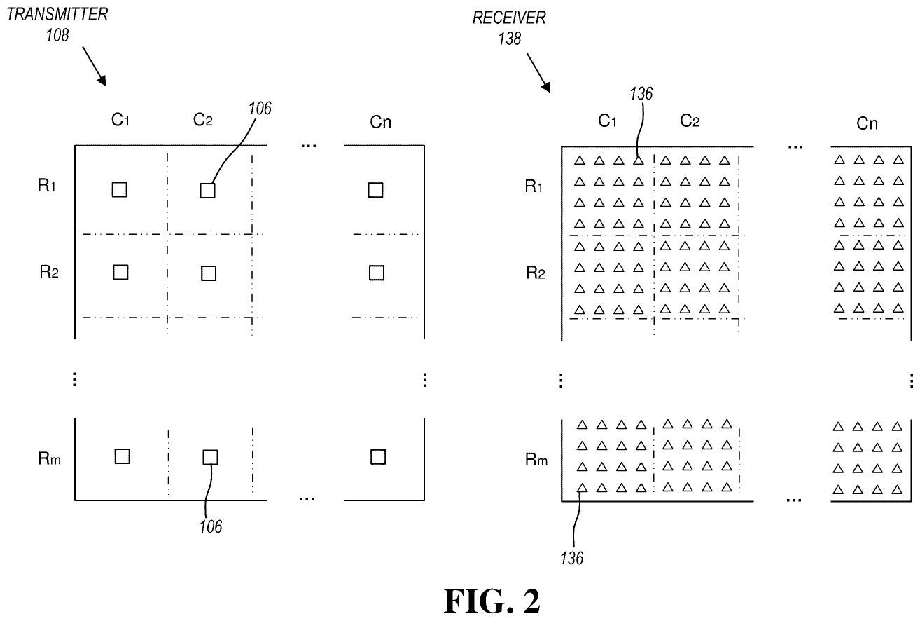

FIG. 2 shows a transmitter module 108 and the receiver module 138 schematically in a front view in accordance with various aspects described herein. Only a partial detail is shown, the additional areas being represented by ellipses in the figure. The transmitter module 108 comprises the emitter elements 106 already described. In some embodiments, the emitter elements are arranged in rows and columns. The columns are designated as [C₁-Cn], and the rows are designated as [R₁-Rm], where n and m represent the number of columns and rows, respectively. The various embodiments may include any number of row and columns (e.g., n and m may take any value).

The receiver module 138 comprises a plurality of sensor elements 136. In some embodiments, the number of sensor elements 136 is equal to the number of emitter elements 106. In other embodiments, as shown in FIG. 2, the number of sensor elements 136 is greater than the number of emitter elements 106. The sensor elements 136 are also implemented in a row and column arrangement. This row and column arrangement is also selected purely as an example. The rows and columns of the receiver module 138 are numbered similar to the rows and columns of the transmitter module 108. In some embodiments, a row and column of receiver module 138 corresponds to the location of a single sensor element 136. In other embodiments, as shown in FIG. 2, a row and column of receiver module 138 corresponds to a location that includes multiple sensor elements 136 (e.g., a macro cell). In the example of FIG. 2, the macro cells are separated from each other by dashed lines for better presentation. In some embodiments, the sensor elements 136 of a macro cell are all assigned to a single emitter element 106. For example, the macro cell located at R1,C2 of receiver module 138 is assigned to the emitter element 106 located at R1,C2 of transmitter module 108. A reflected laser light pulse that was emitted by the sensor element 106 located at R1,C2 of transmitter module 108 images at least a part of the sensor elements 136 of the associated macro cell located at R1,C2 of receiver module 138.

The sensor elements 136 can advantageously be activated and deactivated individually or in groups. As a result, the relevant sensor elements 136 of a macro cell can be activated and the irrelevant ones can be deactivated. This enables the compensation of imaging errors such as, for example, static errors, (e.g., imaging errors of the lens systems 110, 130) or parallax errors (e.g., errors resulting from near objects vs. far objects).

In some embodiments, the emitter elements 106 of the measuring system 100 emit their light pulses sequentially, for example emitter by emitter, column by column, or row by row. This prevents a row or column of emitter elements 106 from triggering the sensor elements 136 of the adjacent row or column of macro cells. In some embodiments, the only sensor elements 136 of the macro cells that are active are those for which the corresponding emitter elements 106 have emitted a laser light pulse.

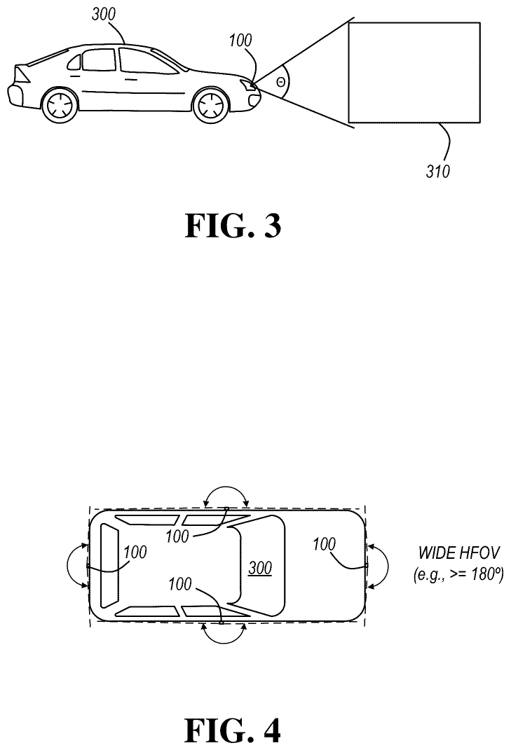

FIG. 3 shows an automotive application of a LIDAR measurement system in accordance with various aspects described herein. As shown in the side view of a vehicle 300 in FIG. 3, vehicle 300 includes LIDAR measurement system 100 at the front of the vehicle. LIDAR measurement system 100 illuminates points within field of view (FOV) 310 with laser light pulses to measure distances as described above. The vertical FOV (VFOV) is shown as angle θ, which can take on any value. Although much of the remainder of this description describes the LIDAR system in the context of an automotive application, the various embodiments described herein are not limited in this respect.

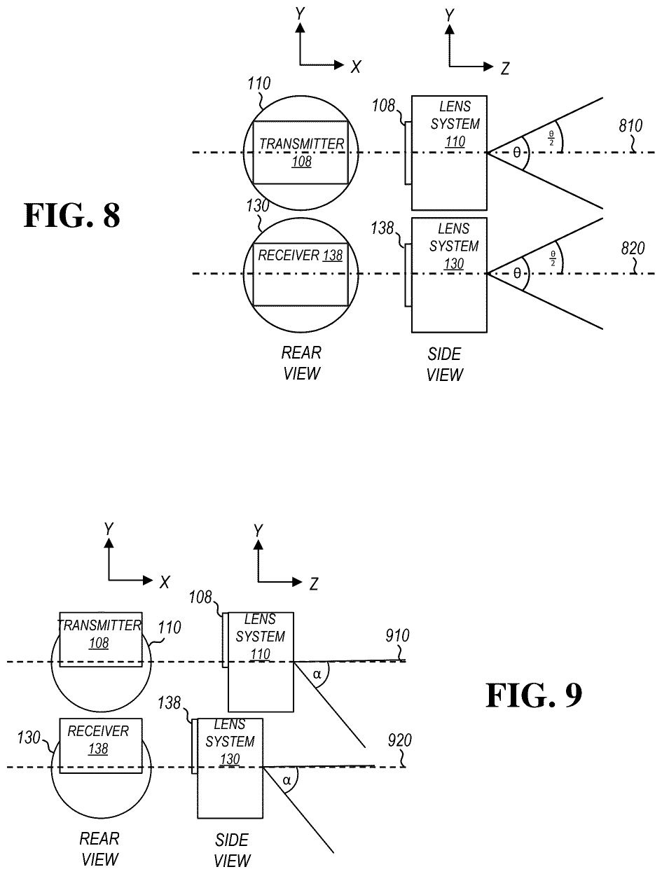

In some embodiments, the vertical field of view θ may be symmetric about a horizontal axis, and in other embodiments, the vertical field of view θ may be asymmetric about a horizontal axis. For example, as described further below with respect to FIGS. 8 and 9, the relative positioning between transmitter and transmitter lens system as well as the relative positioning between receiver and receiver lens system may be altered in a manner that modifies the vertical field of view.

In some embodiments, LIDAR measurement system 100 is positioned just inside a vehicle body panel. For example system 100 may be positioned adjacent to an inside surface of a body panel on the front of vehicle 300 (e.g., a bumper cover). Further, in some embodiments, one or more of the lens systems (e.g., transmitter lens system 110 and/or receiver lens system 130) may protrude through the vehicle body panel to provide a wide field of view.

FIG. 4 shows an automotive application of a LIDAR measurement system in accordance with various aspects described herein. As shown in a top view of vehicle 300 in FIG. 4, vehicle 300 includes a first LIDAR measurement system 100 at the front of the vehicle. In some embodiments, the LIDAR measurement system 100 at the front of the vehicle illuminates points within a wide horizontal field of view (HFOV). For example, in some embodiments, LIDAR measurement system 100 has a HFOV of at least 120 degrees, at least 160 degrees, or at least 180 degrees. In some embodiments, vehicle 300 includes more than one LIDAR measurement system. For example, vehicle 300 may have one or more LIDAR measurement system 100 on sides and rear of the vehicle. In some embodiments, the LIDAR measurement systems 100 at the sides and rear of the vehicle illuminates points within a wide horizontal field of view (HFOV) (e.g, greater than 180 degrees), resulting in a 360 degree view about the vehicle. Also in some embodiments, the LIDAR measurement systems 100 at the sides and rear of the vehicle are positioned adjacent to an inside surface of a vehicle body panel with the transmitting and receiving lens system protruding through the vehicle body panel to allow for a wide HFOV. Although much of the remainder of this description describes the LIDAR system in the context of an automotive application, the various embodiments described herein are not limited in this respect.

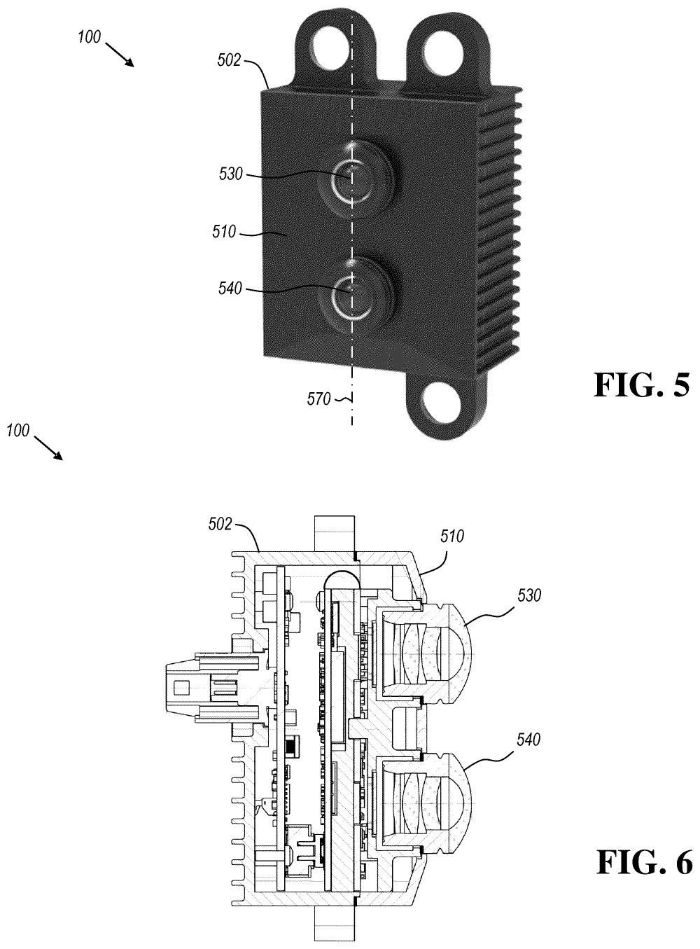

FIG. 5 shows a perspective view of a LIDAR measurement system in accordance with various aspects described herein. Lidar measurement system 100 is shown with housing 502, bezel 510, and lens systems 530 and 540. Lens systems 530 and 540 protrude from within the housing 502 through holes in bezel 510.

Lens system 530 and lens system 540 are oriented on a vertical axis 570 resulting in a top lens system 530 and a bottom lens system 540. In some embodiments, the top lens system 530 is a transmitting lens system and the bottom lens system 540 is a receiving lens system resulting in the transmitter module and the transmitter lens system being positioned vertically above the receiver module and the receiver lens system. In other embodiments, the tops lens system 530 is a receiving lens system and the bottom lens system 540 is a transmitting lens system resulting in the receiver module and the receiver lens system being positioned vertically above the transmitter module and the transmitter lens system. In some embodiments, one of the transmitting lens system and the receiving lens system protrudes further outside the housing than an other of the transmitting lens system and the receiving lens system. For example, in some embodiments, lens system 530 may protrude farther outside of housing 502 than does lens system 540. In these embodiments, the vertical field of view may be extended downwards, in part because light entering or exiting lens system 530 has more room to clear lens system 540. These and other embodiments are described further below.

FIG. 6 shows a cross section view of a LIDAR measurement system in accordance with various aspects described herein. The cross-sectional view of lidar measurement system 100 shows housing 502 with bezel 510. Lens system 530 and lens system 540 are shown protruding through bezel 510, with at least a portion of the lens systems being positioned outside of housing 502.

In the example of FIG. 6, electrical components and other electronics (e.g., transmitter module 108, receiver module 138, control circuit 140, time of flight measurement circuits 150) are positioned inside of housing 502, and lens systems 530 and 540 protrude through bezel 510. Both top lens system 530 and bottom lens system 540 are shown protruding an equal amount through bezel 510, although the amount that the lens systems protrude from bezel 510 may vary. For example, one of lens systems 530 and 540 may protrude further out from bezel 510 than the other lens system. Further, in some embodiments, the total distance that the lens systems protrude from bezel 510 may also vary. For example, in some embodiments, when installed in a motor vehicle, bezel 510 may be positioned on the inside surface of a body panel (e.g., a bumper cover), and the lens systems 530 and 540 protrude far enough outside of bezel 510 such that they also protrude outside of the body panel.

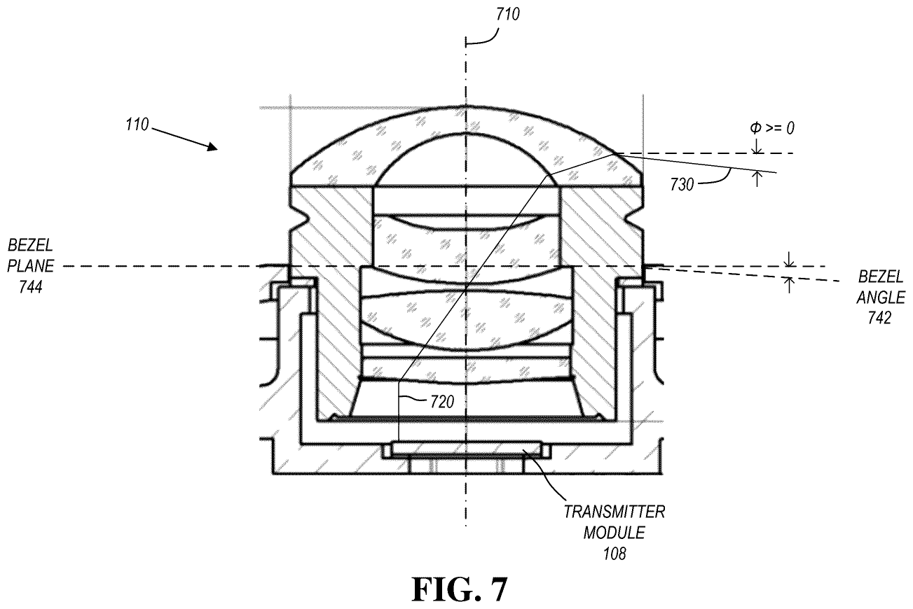

FIG. 7 shows a cross section view of a transmitter module 108 and lens system 110 in accordance with various aspects described herein. A light ray 720 is shown schematically being emitted from transmitter module 108, propagating through transmitter lens system 110 and emanating from the lens system at 730. The path that the light ray takes through transmitting lens system 110 is shown in FIG. 7 as a straight line, however in operation, the actual path of the light ray will typically be something other than a straight line based on the design of the optical elements within transmitting lens system 110.

Transmitting lens system 110 is shown having a principal axis 710. In some embodiments, principal axis 710 extends straight out from housing 502. The optical elements within transmitting lens system 110 result in light ray 730 having an angle @ relative to a plane which is normal to principal axis 710 that provides for a wide field of vice. For example, in some embodiments, the angle @ is greater than or equal to zero degrees. In these embodiments, the field of view in the plane of the page is equal to or greater than 180 degrees. In some embodiments, FIG. 7 represents a top view, and the horizontal field of view is greater than or equal to 180 degrees. Lens system 110 may include any type or number of optical elements capable of performing as described herein. For example, in some embodiments, lens system 110 may include a fisheye lens.

FIG. 7 also shows bezel plane 744 and bezel angle 742, which is the angle that portions of bezel 510 take with respect to bezel plane 744. In some embodiments, principal axis 710 is normal to bezel plane 744. In these embodiments, the angle φ may be expressed as an angle with respect to bezel plane 744. Also in some embodiments, the angle φ may be expressed as an angle with respect to bezel angle 742. For example, in some embodiments, φ and the bezel angle may be equal, resulting in ray 730 being parallel to at least a portion of the bezel, and in other embodiments, the angle φ may be greater than or less than the bezel angle 742.

FIG. 7 has been described with respect to a transmitter module and a transmitting lens system, however all of the embodiments described also apply to a receiver module and a receiver lens system.

FIG. 8 shows transmitter and receiver modules centered on lens systems in accordance with various aspects described herein. In the example of FIG. 8, transmitter module 108 and transmitter lens system 110 are oriented vertically above receiver module 138 and receiver lens system 130.

A rear view of transmitter module 108, transmitter lens system 110, receiver module 138, and receiver lens system 130 are shown on the left side of FIG. 8. A side view of transmitter module 108, transmitter lens system 110, receiver module 138, and receiver lens system 130 are shown on the right side of FIG. 8. In the rear view, the x and y axes in the plane of the page correspond to the plane of transmitter module 108 and receiver module 138 and the corresponding rows and columns of emitter elements 106 and sensor elements 136. In the side view, the z axis corresponds to an axis parallel to the principal axis 810 of transmitter lens system 110, and the principal axis 820 of receiver lens system 130.

In some embodiments, as shown in FIG. 8, transmitter module 108 is positioned symmetrically with respect to transmitter lens system 110, and receiver module 138 is positioned symmetrically with respect to receiver lens system 130. This results in a transmitter vertical field of view θ that is symmetric about the principal axis 810 and a receiver vertical field of view θ that is symmetric about the principal axis 820. Also in some embodiments, as shown in FIG. 8, transmitter lens system 110 and receiver lens system 130 protrude equal amounts from the bezel (not shown). For example, in both the rear view and the side view of FIG. 8, transmitter lens system 110 and receiver lens system 130 are shown vertically aligned.

FIG. 9 shows transmitter and receiver modules offset on lens systems in accordance with various aspects described herein. In the example of FIG. 9, transmitter module 108 is positioned off center with respect to transmitter lens system 110, and receiver module 138 is positioned off center with respect to receiver in system 130. This results in a transmitter vertical field of view α that is asymmetric about the principal axis 810 and a receiver vertical field of view α that is asymmetric about the principal axis 820. In the example of FIG. 9, the lower vertical field of view is increased and the upper vertical field of view is decreased. Also in some embodiments, as shown in FIG. 9, transmitter lens system 110 protrudes further from the bezel (not shown) than receiver lens system 130. For example, transmitter lens system 110 and receiver lens system 130 are vertically aligned in the rear view of FIG. 9, but transmitter lens system 110 protrudes further to the right in the side view of FIG. 9.

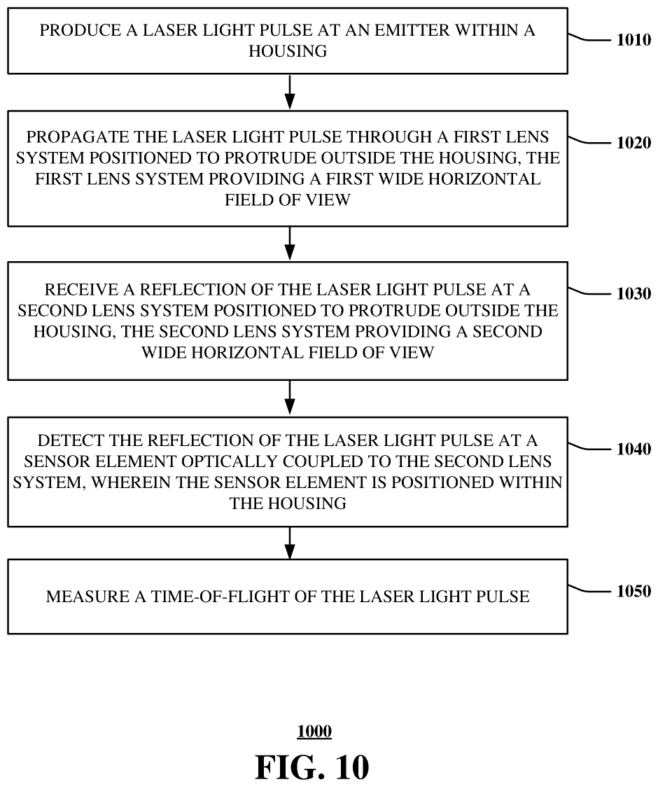

FIG. 10 depicts an illustrative embodiment of a method in accordance with various aspects described herein. In some embodiments, method 1000, or portions thereof, is performed by a LIDAR measurement system. In other embodiments, method 1000 is performed by a larger system such as a vehicle. Method 1000 is not limited by the particular type of apparatus performing the method. The various actions in method 1000 may be performed in the order presented or may be performed in a different order. Further, in some embodiments, some actions listed in FIG. 10 are omitted from method 1000.

Method 1000 is shown beginning with block 1010 in which a laser light pulse is produced at an emitter within a housing. In some embodiments, the laser light pulse may be produced by an emitter within a transmitter module, such as emitter 106 (FIGS. 1, 2). In some embodiments, the characteristics of the laser light pulse (e.g., power, pulse width, timing, etc.) are configured by a control circuit, such as control circuit 140 (FIG. 1). Examples of housings holding one or more emitters are shown in FIGS. 5 and 6 at housing 502.

At 1020, the laser light pulse is propagated through a first lens system positioned to protrude outside the housing, the first lens system providing a first wide horizontal field of view (e.g., at least 180 degrees). The first lens system corresponds to transmitter lens system 110. In some embodiments, the emitter is part of a transmitter module that is positioned relative to the first lens system. The transmitter module may be positioned symmetrically relative to the first lens system such that a vertical field of view is symmetric about a principal axis of the first lens system. The transmitter module may also be positioned off center relative to the first lens system such that a vertical field of view is asymmetric about a principal axis of the first lens system. In some embodiments, the first lens system may be a top lens system such as lens system 530 (FIGS. 5, 6) or a bottom lens system such as lens system 540 (FIGS. 5, 6). In some embodiments, the first lens system may be a transmitter lens system of a LIDAR measurement system in use on a motor vehicle. For example, as shown in FIG. 4, one or more LIDAR measurement systems 100 with a wide field of view may be utilized on a motor vehicle. In some embodiments, the first lens system protrudes through, and extends beyond, a vehicle body panel.

At 1030, a reflection of the laser light pulse is received at a second lens system positioned to protrude outside the housing, the second lens system providing a second wide horizontal field of view (e.g., least 180 degrees). The second lens system corresponds to receiver lens system 130. In some embodiments, the second lens system may be a top lens system such as lens system 530 (FIGS. 5, 6) or a bottom lens system such as lens system 540 (FIGS. 5, 6). In some embodiments, the second lens system may be a receiver lens system of a LIDAR measurement system in use on a motor vehicle. For example, as shown in FIG. 4, one or more LIDAR measurement systems 100 with a wide field of view may be utilized on a motor vehicle. In some embodiments, the first lens system and the second lens system protrude equal amounts outside of the housing and/or outside a vehicle body panel. In other embodiments, the first lens system and the second lens system protrude unequal amounts outside of the housing and/or vehicle body panel.

At 1040, a reflection of the laser light pulse is detected at a sensor element optically coupled to the second lens system where in the sensor element is positioned within the housing. In some embodiments, the sensor element is part of a receiver module that is positioned relative to the second lens system. The receiver module may be positioned symmetrically relative to the second lens system such that a vertical field of view is symmetric about a principal axis of the second lens system. The receiver module may also be positioned off center relative to the second lens system such that a vertical field of view is asymmetric about a principal axis of the second lens system.

At 1050, a time-of-flight of the laser light pulse is measured to determine a distance between the LIDAR measurement system and an object from which the laser light pulse was reflected.

While for purposes of simplicity of explanation, the respective processes are shown and described as a series of blocks in FIG. 10, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A system, comprising:
a housing;
a transmitter module positioned within the housing, the transmitter module including a plurality of emitter elements to emit laser light pulses into a field of view;
a transmitter lens system optically coupled to the transmitter module, the transmitter lens system positioned at least partly outside the housing to provide a wide transmitter horizontal field of view;
a receiver module positioned within the housing, the receiver module including a plurality of sensor elements to detect reflected laser light pulses from the field of view; and
a receiver lens system optically coupled to the receiver module, the receiver lens system positioned at least partly outside the housing to provide a wide receiver horizontal field of view.

2. The system of claim 1, wherein the transmitter module is positioned relative to the transmitter lens system to provide a symmetric vertical field of view.

3. The system of claim 1, wherein the transmitter module is positioned relative to the transmitter lens system to provide an asymmetric vertical field of view.

4. The system of claim 1, wherein the wide transmitter horizontal field of view and the wide receiver horizontal field of view are both at least 180 degrees.

5. The system of claim 1, wherein the transmitter module and the transmitter lens system are positioned vertically above the receiver module and the receiver lens system.

6. The system of claim 1, wherein the receiver module and the receiver lens system are positioned vertically above the transmitter module and the transmitter lens system.

7. The system of claim 1, wherein the housing comprises a bezel, and wherein the transmitting lens system and receiving lens system protrude through holes in the bezel.

8. The system of claim 1, wherein the transmitting lens system and the receiving lens system are oriented vertically, and wherein one of the transmitting lens system and the receiving lens system protrudes further outside the housing than an other of the transmitting lens system and the receiving lens system.

9. The system of claim 1, wherein the housing is positioned adjacent to an inside surface of a vehicle body panel, and wherein the transmitting lens system and the receiving lens system protrude through the vehicle body panel.

10. A light detection and ranging (LIDAR) measurement system, comprising:
a transmitter module and transmitter lens system oriented on a vertical axis of the LIDAR measurement system; and
a receiver module and receiver lens system oriented on the vertical axis of the LIDAR measurement system, wherein one of the transmitter lens system and the receiver lens system is a top lens system, and an other of the transmitter lens system and the receiver lens system is a bottom lens system;
wherein the top lens system and bottom lens system are positioned to protrude through a bezel, and wherein the top lens system is positioned to protrude further through the bezel than the bottom lens system to provide an increased lower vertical field of view.

11. The LIDAR measurement system of claim 10, wherein the top lens system comprises the transmitter lens system and the bottom lens system comprises the receiver lens system.

12. The LIDAR measurement system of claim 10, wherein the top lens system comprises the receiver lens system and the bottom lens system comprises the transmitter lens system.

13. The LIDAR measurement system of claim 10, wherein the transmitter module includes an array of emitter elements capable of emitting laser light pulses.

14. The LIDAR measurement system of claim 13, wherein the transmitter module is positioned off center with respect to a first principal axis of the transmitter lens system.

15. The LIDAR measurement system of claim 14, wherein the receiver module includes an array of sensor elements capable of detecting reflections of the laser light pulses.

16. The LIDAR measurement system of claim 15, wherein the receiver module is positioned off center with respect to a second principal axis of the receiver lens system.

17. The LIDAR measurement system of claim 10, wherein the transmitter lens system comprises a first fisheye lens that provides a first horizontal field of view at least 180 degrees.

18. The LIDAR measurement system of claim 17, wherein the receiver lens system comprises a second fisheye lens that provides a second horizontal field of view at least 180 degrees.

19. A method, comprising:
producing a laser light pulse at an emitter positioned within a housing;
propagating the laser light pulse through a first lens system positioned to protrude outside the housing, the first lens system providing a first horizontal field of view of at least 180 degrees;
receiving a reflection of the laser light pulse at a second lens system positioned to protrude outside the housing, the second lens system providing a second horizontal field of view of at least 180 degrees; and
detecting the reflection of the laser light pulse at a sensor element optically coupled to the second lens system, wherein the sensor element is positioned within the housing.

20. The method of claim 19, further comprising measuring a time-of-flight of the laser light pulse.
